(19) United States
(12) Patent Application Publication
(10) Pub. No.: US 2023/0316041 A1
(43) Pub. Date: Oct. 5, 2023

(54) MODIFIED DEEP LEARNING MODELS WITH DECISION TREE LAYERS

(71) Applicant: International Business Machines Corporation, Armonk, NY (US)

(72) Inventors: Zhong Fang Yuan, Xian (CN); Tong Liu, Xian (CN); Hai Bo Zou, Beijing (CN); Si Heng Sun, Xian (CN); Na Liu, Xian (CN)

(21) Appl. No.: 17/657,103

(22) Filed: Mar. 29, 2022

(51) Int. Cl. G06N 3/04; G06N 3/08

(52) U.S. Cl. CPC G06N 3/0427; G06N 3/08

(57) ABSTRACT

Disclosed are techniques for modifying deep learning models (such as neural networks) to run more efficiently in computing environments with limited floating point computation resources. A deep learning model is trained using a set of training data. Input and output values are then recorded from the layers of the trained model when supplied with the training data, which are then used to generate deep forest decision tree models corresponding to individual layers of the trained model. Experimental versions of the trained model are then generated with different layers of the trained model replaced with their corresponding deep forest decision tree models. These experimental versions are then ranked according to the accuracy of their results compared to the results of the trained model. An updated trained model is then generated with one or more layers replaced with their corresponding deep forest decision tree models.

### BACKGROUND

The present invention relates generally to the field of machine learning, and more particularly to accelerating inferencing in neural network models on central processing units.

Machine learning (ML) refers to the study of computer algorithms which can improve automatically through experience and through the use of data. It is viewed as a part of the field of artificial intelligence. Machine learning algorithms construct a model based on sample data, known as “training data” in order to make predictions or decisions without being explicitly programmed to do so. Machine learning algorithms are leveraged in a wide variety of applications, such as in medicine, email filtering, speech recognition, and computer vision, where it is difficult or unfeasible to develop conventional algorithms to complete the needed tasks.

Deep learning (also known as deep structured learning) is a segment of a broader family of machine learning techniques based on artificial neural networks with representation learning. Learning may be unsupervised, semi-supervised, or supervised. Deep learning is a subset of machine learning algorithms which utilizes a plurality of layers to progressively extract higher-level features from the raw input. For example, in the field of image processing, lower layers might identify edges, while layers higher up may identify the concepts relevant to a human such as digits, faces, letters, or objects.

Artificial neural networks (ANNs), usually simplified as neural networks (NNs), are computer systems. An ANN is made up of computing nodes (sometimes herein referred to as “neurons”) and connections between the nodes (also herein referred to as edges). Each node receives input data from one or more source(s), sums the inputs of its sources, applies a non-linear function to the sum to obtain output data and then outputs the output data to other node(s) of the ANN according to the scheme of connections of the ANN. The nodes are organized into a series of successive “network layers,” where each network layer typically includes multiple nodes. There are three types of network layers as follows: (i) an input layer receives input data from source(s) external to the ANN; (ii) a set of hidden layer(s) (typically more than one) receives input data from the input layer (in the case of the first hidden layer) or from node(s) of the immediately previous hidden layer; and (iii) an output layer whose nodes receive their input(s) from the last hidden layer and output the final results of the ANN computing. Each inter-nodal edge typically applies weighting function to the data it carries from a source node to node(s) in the next layer of the ANN. When machine learning is applied to refine the ANN over time, these weighting functions of the various connections of the ANN are adjusted as learning proceeds.

Decision tree learning is a predictive modelling approach utilized in statistics, data mining and machine learning. It uses a decision tree (as a predictive model) to move from observations about an item (represented in the branches) to conclusions about the item's target value (represented in the leaves). Tree models with target variables that may take a discrete set of values are described as classification trees; in these tree structures, leaves correspond to class labels and branches correspond to conjunctions of features that lead to those class labels. Decision trees with target variables that may take continuous values (typically real numbers) are described as regression trees.

In mathematics, a tensor is refers to an algebraic object which describes a multilinear relationship between sets of algebraic objects related to a vector space. Objects which tensors can map between include vectors and scalars, as well as other tensors. There are a multitude of types of tensors, including scalars and vectors (which are the simplest types of tensors), dual vectors, multilinear maps between vector spaces, and even certain operations such as dot products. Tensors are defined independent of any basis, although they are commonly referred to by their components in a basis related to a particular coordinate system.

Neural networks typically include “network layers.”

### SUMMARY

According to an aspect of the present invention, there is a method, computer program product and/or system that performs the following operations (not necessarily in the following order): (i) receiving a deep learning model with corresponding training input datasets and training labels; (ii) extracting output tensors from network layers of the deep learning model; (iii) for at least some network layers of the deep learning model, training a set of tree models, where a given tree model corresponds to an individual network layer; and (iv) generating a set of experimental deep learning models, with each experimental deep learning model corresponding to a copy of the deep learning model having a different network layer replaced with a tree model from the set of decision tree models.

According to an aspect of the present invention, there is a method, computer program product and/or system that performs the following operations (not necessarily in the following order): (i) receiving a deep learning model with corresponding training input datasets and training labels; (ii) extracting output tensors from network layers of the deep learning model; (iii) for at least some network layers of the deep learning model, training a set of tree models, where a given tree model corresponds to an individual network layer; (iv) generating a set of experimental deep learning models, with each experimental deep learning model corresponding to a copy of the deep learning model having a different network layer replaced with a tree model from the set of decision tree models; and (v) ranking the experimental deep learning model of the set of experimental deep learning models based, at least in part, on an accuracy metric.

According to an aspect of the present invention, there is a method, computer program product and/or system that performs the following operations (not necessarily in the following order): (i) receiving a deep learning model with corresponding training input datasets and training labels; (ii) extracting output tensors from network layers of the deep learning model; (iii) for at least some network layers of the deep learning model, training a set of tree models, where a given tree model corresponds to an individual network layer; (iv) generating a set of experimental deep learning models, with each experimental deep learning model corresponding to a copy of the deep learning model having a different network layer replaced with a tree model from the set of decision tree models; and (v) ranking the experimental deep learning model of the set of experimental deep learning models based, at least in part, on an accuracy metric. Wherein the accuracy metric is determined by comparing output of the experimental deep learning models with output of the deep learning model using the training input datasets and the training labels.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a block diagram showing a neural network according to a second embodiment method of the present invention;

FIG. 5 is a block diagram of components of a neural network according to the second embodiment method of the present invention;

FIG. 6A is a block diagram showing inputs and outputs of an example network layer of the neural network for use in training tree models according to the second embodiment method;

FIG. 6B is a block diagram showing tree models trained using the inputs and outputs of the example network layer of the neural network according to the second embodiment method; and

FIG. 7 is a block diagram showing an example experiment neural network with replaced network layer according to the second embodiment method.

### DETAILED DESCRIPTION

Some embodiments of the present invention are directed to techniques for modifying deep learning models (such as neural networks) to run more efficiently in computing environments with limited floating point computation resources. A deep learning model is trained using a set of training data. Input and output values are then recorded from the layers of the trained model when supplied with the training data, which are then used to generate deep forest decision tree models corresponding to individual layers of the trained model. Experimental versions of the trained model are then generated with different layers of the trained model replaced with their corresponding deep forest decision tree models. These experimental versions are then ranked according to the accuracy of their results compared to the results of the trained model. An updated trained model is then generated with one or more layers replaced with their corresponding deep forest decision tree models.

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium (sometimes referred to as “machine readable storage medium”) can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be any thing made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

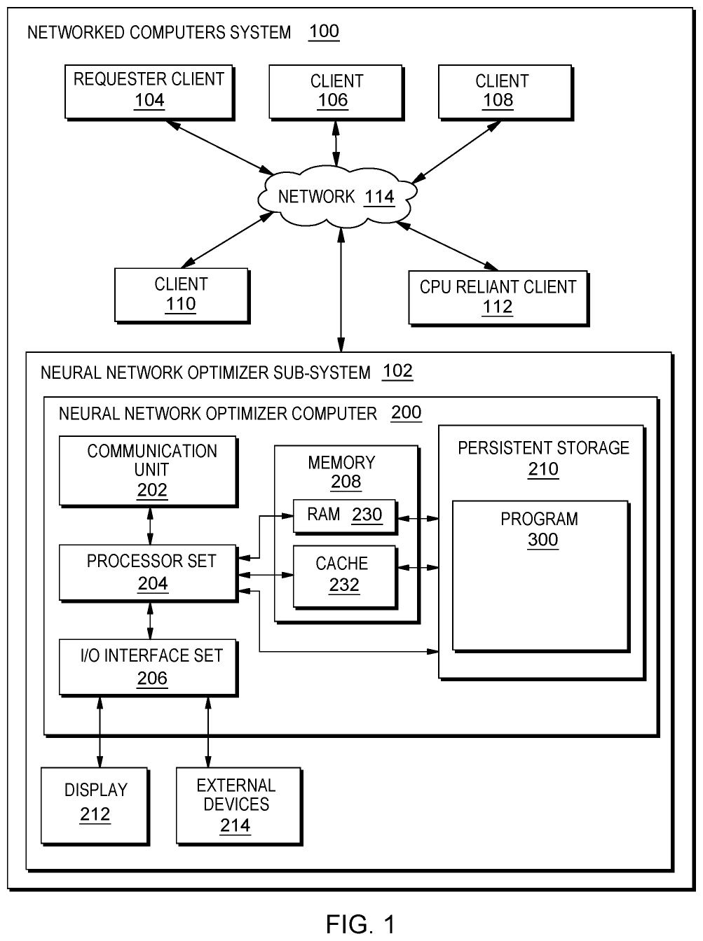

As shown in FIG. 1, networked computers system 100 is an embodiment of a hardware and software environment for use with various embodiments of the present invention described in detail with reference to the Figures. Networked computers system 100 includes: neural network optimizer subsystem 102 (sometimes herein referred to, more simply, as subsystem 102); client subsystems 104, 106, 108, 110; CPU reliant client 112; and communication network 114. Subsystem 102 includes: neural network optimizer computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with neural network optimizer computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

CPU reliant client 112 is a client computer device with limited processing capabilities for processing floating point operations, measured in FLOPS, which neural network inferencing operations are primarily comprised of. CPUs are commonly understood to be capable of processing logical operations more efficiently than floating point operations. As such, CPU reliant client 112 does not include a floating-point unit or other specialized hardware for processing floating point operations efficiently. In some alternative embodiments, CPU reliant client 112 may include specialized hardware for processing floating point operations, but such hardware is unavailable for inferencing activities of one or more neural networks.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

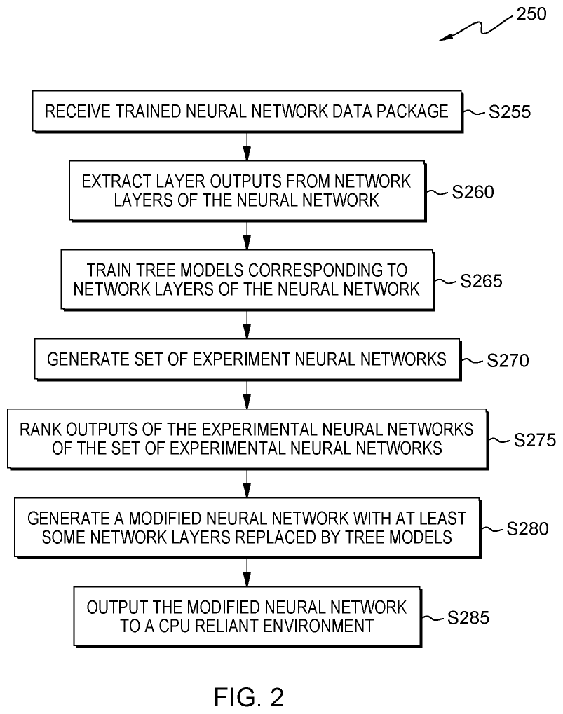

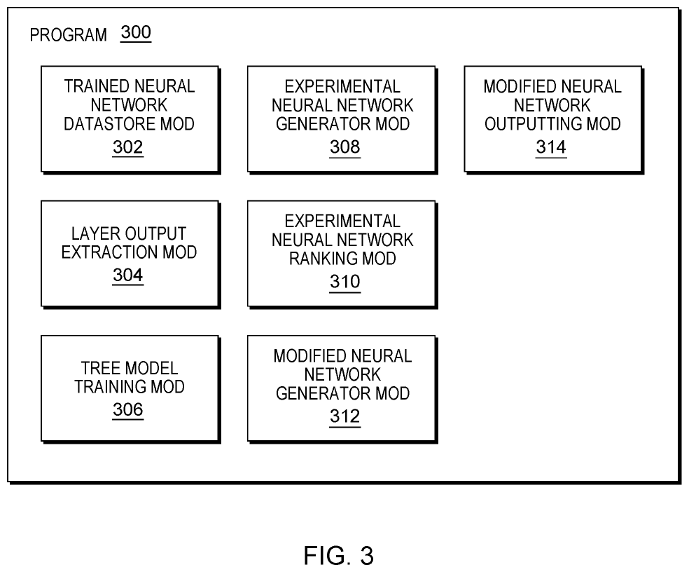

As shown in FIG. 1, networked computers system 100 is an environment in which an example method according to the present invention can be performed. As shown in FIG. 2, flowchart 250 shows an example method according to the present invention. As shown in FIG. 3, program 300 performs or control performance of at least some of the method operations of flowchart 250. This method and associated software will now be discussed, over the course of the following paragraphs, with extensive reference to the blocks of FIGS. 1, 2 and 3.

Processing begins at operation S255, where trained neural network datastore module (“mod”) 302 receives a trained neural network data package. In this simplified embodiment, the trained neural network data package includes: (i) a trained neural network; and (ii) training data corresponding to training input data and training labels used to train the neural network. The training labels served as objective answers to compare against the output of the trained neural network when provided the training input data during training. The trained neural network is tasked with identifying apples or tomatoes in images and includes three layers: (i) a first layer; (ii) a second layer; and (iii) a third layer. For the trained neural network, the first layer receives a set of input data to be processed by the neural network, which is initially processed by the first layer. The first layer then outputs a set of tensors to the second layer, referred to as “the first layer output tensors”, which receives the first layer output tensors as input. The second layer next processes the first layer output tensors and outputs a new set of tensors to the third layer, referred to as the second layer output tensors, which are received as input by the third layer. The third layer next processes the second layer output tensors and outputs a set of labels corresponding to the input data selected from the set consisting of: (i) apple; (ii) tomato; (iii) both; and (iv) neither. In some alternative embodiments, the trained neural network may include any number of layers and correspond to any type of task suitable for neural networks. In further alternative embodiments, the neural network is representative of deep learning models, and may be substituted with any type of deep learning model with multiple layers with significant floating point operations.

Processing proceeds to operation S260, where layer output extraction mod 304 extracts output tensors for network layers of the neural network. In this simplified embodiment, layer output extraction mod 304 extracts tensors from the three layers of the trained neural network by providing the training input data to the trained neural network and monitoring the output from each layer of the trained neural network as each layer processes their respective inputs. Accordingly, the training input data (for example, a set of images), is provided to the trained neural network, one image at a time, and initially processed by the first layer. The first layer processes the image(s) and outputs a set of tensors (which are recorded by layer output extraction mod 304) to the second layer. The second layer processes these tensors and outputs another set of tensors (which are also recorded by layer output extraction mod 304) to the third layer. The third layer processes this set of tensors and outputs a set of labels (which are also recorded by layer output extraction mod 304).

Processing proceeds to operation S265, where tree model training mod 306 trains tree models corresponding to network layers of the neural network. In this simplified embodiment, a tree model is trained for each network layer of the trained neural network, which includes three network layers. Each network layer corresponds to a layer of processing in the trained neural network for outputting a set of labels from a set of raw input data. In this simplified embodiment, the tree model generated for each layer is a deep forest model, which comprises an ensemble of decision trees. For a given layer, a deep forest is trained using the input provided to the layer as training input data and the output for that layer (extracted at S260) used as labels to compare outputs of the deep forest against. The deep forest model trained until it returns similar output values (for example, within a provided tolerance range, such as within a percentage of deviation) to the given layer when provided the same set of input values. In this simplified embodiment, three deep forest models are trained, where each deep forest model corresponds to one of the three layers of the trained neural network including: (i) a first deep forest model corresponding to the first layer; (ii) a second deep forest model corresponding to the second layer; and (iii) a third deep forest model corresponding to the third layer. In some alternative embodiments, tree models are trained corresponding only to some, but not all, of the layers of the trained neural network. In yet other alternative embodiments, the deep forest model is replaced by any type of decision tree model which can be trained to produce similar output to a given network layer when provided similar input data.

Processing proceeds to operation S270, where experimental neural network generator mod 308 generates a set of experimental neural networks. In this simplified embodiment, the set of experimental neural networks includes three experimental neural networks: (i) a first experimental neural network corresponding to a copy of the trained neural network with the first layer replaced with the first deep forest model; (ii) a second experimental neural network corresponding to a copy of the trained neural network with the second layer replaced with the second deep forest model; and (iii) a third experimental neural network corresponding to a copy of the trained neural network with the third layer replaced with the third deep forest model. An experimental neural network is generated for each generated tree model from S265, where each tree model corresponds to one layer of the trained neural network. In replacing a layer of the trained neural network, each node of a given layer is replaced by corresponding deep forest model. Each of these networks are experimental in nature to determine which network layers of the trained neural network are most suitable for replacement with tree models.

Processing proceeds to operation S275, where experimental neural network ranking mod 310 ranks outputs of the experimental neural networks of the set of experimental neural networks. In this simplified embodiment, experimental neural network ranking mod 310 ranks the outputs of the experimental neural networks by providing the training input data to each experimental neural network, which each respectively processes the training input data throughout their various layers, ultimately outputting a set of output data. The resulting output data from each experimental neural network is then benchmarked against the output data from the trained neural network when provided the same training input data, assigning a score (or accuracy metric) to each experimental neural network based on the difference between the output data of a given experimental neural network and the output data from the trained neural network. These scores are then ranked by experimental neural network ranking mod 310 from low to high, with low scores corresponding to experimental neural networks that outputted output data most similar to the output data of the trained neural network (or having a lesser impact on the overall accuracy of the neural network when replacing their corresponding network layers). In this simplified embodiment, experimental neural network ranking mod 310 ranks the experimental neural networks as follows: (1) the second experimental neural network; (2) the first experimental neural network; and (3) the third experimental neural network.

Processing proceeds to operation S280, where modified neural network generator mod 312 generates a modified neural network with at least some network layers replaced by tree models. In this simplified embodiment, the modified neural network is a copy of the trained neural network with a number of layers replaced with deep forest models, with the number of layers replaced limited to less than the total number of layers in the trained neural network model. For example, in this simplified embodiment, the trained neural network comprises three layers. Correspondingly, the maximum number of layers that may be replaced by deep forest models in the modified neural network is two. Modified neural network generator mod 312 generates the modified neural network based on a set of rules and the ranked outputs of experimental neural networks. In this simplified embodiment, the set of rules dictates that the network layers corresponding to experimental neural networks with the two lowest ranked outputs are replaced with their corresponding deep forest model in the modified neural network, resulting in a modified neural network comprising the following layers: (1) the first deep forest model; (2) the second deep forest model; and (3) the third layer.

In some alternative embodiments, different rules are applied to determine the modified neural network. One set of alternative rules are based on an accuracy threshold, where experimental neural networks with outputs that differ from the outputs of the trained neural network beyond a threshold value correspond to network layers that are ineligible for replacement with tree models regardless of their relative ranking to other network layers. In another set of alternative rules, the maximum number of layers that may be replaced is different than one less than the maximum (for example, two less than the maximum, three less than the maximum . . . etc., or a percentage of the total number of layers of the trained neural network, such as 75%, 66%, 50%, 33%, 25%, etc.) In yet further alternative embodiments, the set of rules indicates that there is a desired performance target for the modified neural network. For example, the modified neural network should output an output set within a set amount of time of receiving an input dataset. Based on this rule, modified neural network generator mod 312 generates the modified neural network by replacing one network layer at a time, based on the ranking of experimental neural networks, until this performance target is received.

In some further alternative embodiments, the desired performance target is a minimum accuracy threshold, corresponding to a maximum amount of deviation tolerated between output from the modified neural network relative to output of the trained neural network. Based on this rule, modified neural network generator mod 312 generates the modified neural network by replacing one network layer at a time, based on the ranked experimental neural networks, until this performance target is exceeded, and then reverses the immediately preceding replacement that resulted in exceeding the performance target, resulting in a modified neural network with as many layers replaced with tree models as possible without exceeding the performance target (which in this example corresponds to accuracy deviation from the trained neural network.) In the present embodiment, the set of rules are predetermined, but in some alternative embodiments they are received with the trained neural network.

Processing proceeds to operation S285, where modified neural network outputting mod 314 outputs the modified neural network to a CPU reliant environment. In this simplified embodiment, the CPU reliant environment is CPU reliant client 112. CPU reliant client 112 executes the modified neural network using CPU resources, generating a corresponding set of output data from received images.

### III. Further Comments and/or Embodiments

Some embodiments of the present invention recognize the following facts, potential problems and/or potential areas for improvement with respect to the current state of the art: (i) for some problems in industrial scenarios, some complex deep neural networks are often used; (ii) however, in many scenarios, due to resource constraints, model inferences often have to be performed in the CPU environment, resulting in slow inference speeds and failing to meet the online standards; (iii) the reason for the unsatisfactory performance of the deep neural network model in the CPU environment is that the deep neural network involves a large number of floating-point matrix operations, and the process of the CPU determines that it is more suitable for logical operations and not suitable for doing Floating-point matrix operations; (iv) this reason is the main reason for the poor performance of the deep learning model in the CPU environment; (v) however, in some scenarios, there exists a need to optimize the performance of the deep learning model in the CPU scenario; and (vi) this contradiction is also the main pain point of this problem.

Some embodiments of the present invention may include one, or more, of the following operations, features, characteristics and/or advantages: (i) the technique can improve deep learning model performance in CPU processing scenarios; (ii) converting the computationally complex nodes in the neural network into decision nodes has very little effect on the model's accuracy; (iii) the essence of this pain point is that CPU is not good at processing matrix-level floating-point operations that need to be parallel; (iv) in contrast, CPUs are very good at processing decision-making operations (logical computing tasks); (v) for example, CPUs can very efficiently process thousands of “if-else operations”, and also efficiently process tree machine learning models such as decision trees and random forests; (vi) faced with the above problems, proposed is a technique of replacing certain network layers in a neural network with a decision tree model through a self-learning method, because the CPU can process tree-type models much faster than neural network models; (vii) therefore, this type of solution can achieve the effect of speeding up the inference speed in CPU scenario processing scenarios; (viii) according to the foregoing, in order to improve the performance of the deep learning model in the CPU environment, some network layers in the deep neural network need to be replaced with a decision tree type model; (ix) train a deep learning model in a normal way as the model to be optimized; and (x) pass the training data through each layer of the network to be optimized in turn and record the input vector and output vector of each layer of the network.

Some embodiments of the present invention may include one, or more, of the following operations, features, characteristics and/or advantages: (i) for each layer of the deep learning network, a corresponding deep forest model (a type of decision tree model) is trained; (ii) the training data of each deep forest model is the input vector of this layer of the network, and the label is the output vector of this layer of the network; (iii) this training is to make the trained deep forest model simulate the output and input of this layer of neural network as much as possible in terms of model utility; (iv) in the process of training the deep forest model, if the training data is sufficient, it can even introduce the phenomenon of over-fitting (that is, the tree model is absolutely adequately fitted) so that the trained deep forest can better fit the replaced neural network; (v) this is a strategy of using a model to train another model; (vi) when the tree-type model is fully trained or even close to overfitting, it can be approximated as a collection of a series of if-else operations; (vii) these logical operations are very suitable for CPU; (viii) the forest model can be seen as a collection of multiple tree models, and its training and speculation are also very suitable for parallel operations at the CPU level; (ix) tree models are not suitable for completely replacing all of the network layers because the tree model is not good at extracting features from raw data such as images or text; (x) the effect of using the tree model at the beginning is usually not good; (xi) this solution uses a tree model to simulate the input and output of each level of the neural network; and (xii) it is essentially a tree regression model, and this type of tree model is very good at it.

Some embodiments of the present invention may include one, or more, of the following operations, features, characteristics and/or advantages: (i) it can be seen from the above that for the deep learning model to be optimized, we use the input and output of the network layer itself in this model to train a model that simulates the input and output of the network layer; (ii) however, because decision tree models have a certain gap in data fitting ability compared with deep learning models, if all network layers are replaced with decision tree models, the accuracy of the model will definitely be greater; (iii) decline, and this is what we don't want to see; (iv) therefore, according to the data situation, one or more layers of the network in the model to be optimized will be dynamically replaced with the corresponding decision tree model; (v) the specific operation method is as follows; (vi) for an N-layer network, perform N experiments; (vii) in each experiment, replace only one network layer with a decision tree model and test it on the test set; (viii) after each test, record the accuracy of the new model on the test set for this experiment and compare it with the accuracy of the original model without replacing the network; (ix) the difference between the accuracy of the two models is the accuracy of the replaced decision tree model and the original network layer; (x) after completing N experiments, record (or sort) the accuracy differences in order from low to high; (xi) after the sorting is completed, the models corresponding to the accuracy differences will also have an order; (xii) this order is the trained decision tree model rank of the replaceability of its corresponding network layer; and (xii) in actual use, we can select 1-N network layers to replace according to the above-mentioned replaceability ranking and the accuracy and response speed requirements in real projects.

Some embodiments of the present invention may include one, or more, of the following operations, features, characteristics and/or advantages: (i) improve the machine learning performance for CPU; (ii) speeding up the inference speed of complex deep neural networks in the CPU scenario; (iii) speed up the inference speed of complex deep neural networks in the CPU scenario by replacing certain network layers in a neural network with a decision tree model through a self-learning method; and (iv) converting the neural network structure; not removing nodes or edges, so our method has high accuracy.

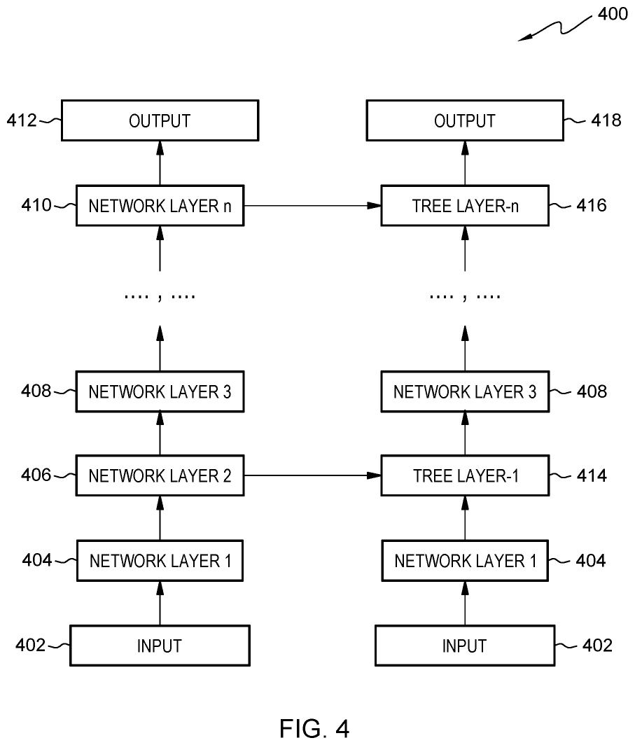

Diagram 400 of FIG. 4 shows a neural network model with some layers replaced with decision trees, including: (i) input 402; (ii) network layer 404; (iii) network layer 406; (iv) network layer 408; (v) network layer n 410; output 412; (vi) tree layer 1 414; (vii) tree layer n 416; and (viii) output 418. In this model, network layer 2 406 is replaced with tree layer 1 414 and network layer n 410 is replaced with tree layer n 416. The model on the right is the result of selecting 1 to N network layers for replacement with tree layers according to accuracy and response speed requirements of a given project.

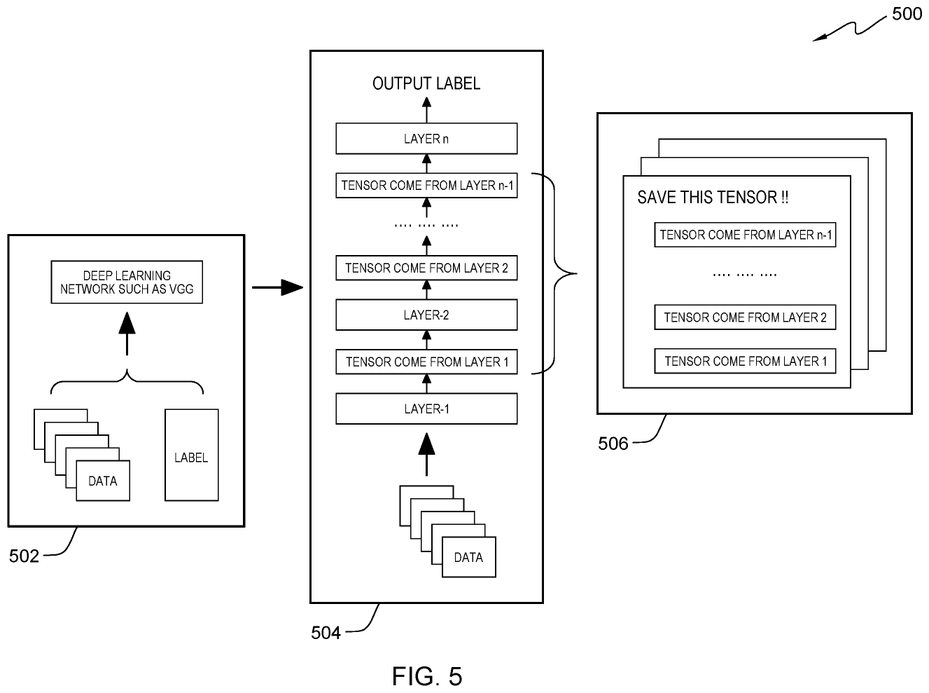

Diagram 500 of FIG. 5 shows several views of a neural network and corresponding tensors according to some embodiments of the present invention, including: (i) neural network training 502; (ii) neural network layers 504; and (iii) layer tensor outputs 506. Shown in 502, a neural network is trained using a set of training data and corresponding labels. Shown in 504, the trained neural network is shown as a sequence of layers beginning with an input dataset and terminating in a set of output labels, with each intervening layer outputting a set of tensors. Shown in 506 is the tensors outputted by each layer, saved and set aside for subsequent use in training tree layers.

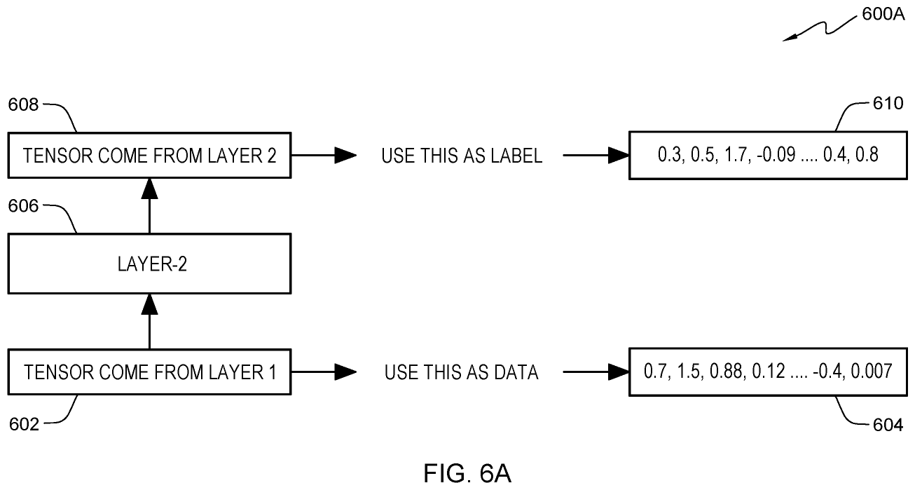

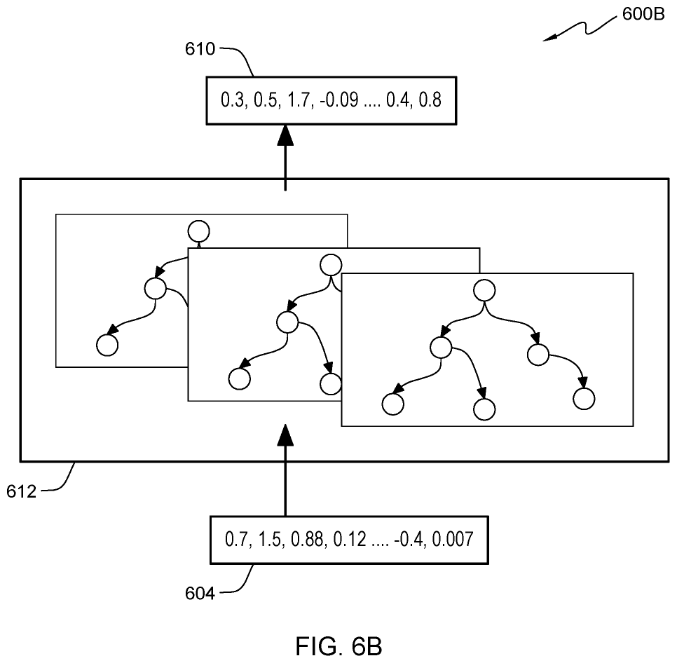

Diagram 600A of FIG. 6A shows an example of one layer of the neural network shown in FIG. 5, including: (i) tensor from layer 1 602; (ii) tensor data 604; (iii) layer 2 606; (iv) tensor from layer 2 608; and (v) tensor data 610. Tensor data 604 corresponds to the tensor from layer 1 602, and tensor data 610 corresponds to tensor from layer 2 608. Tensor data 604 and tensor data 610 are used to train a tree layer for replacing layer 2 606, shown in FIG. 6B.

Diagram 600B of FIG. 6B shows tree set 612, which are trained using tensor data 604 as input and tensor data 610 as labels for evaluating the accuracy of the trees in tree set 612. The trees in tree set 612 are candidates for replacing layer 2 606 shown in FIG. 6A. This is an example showing one layer of a neural network model; in some embodiments, a similar process is applied to each layer of the neural network model, where input tensors for a given layer are used as input for training deep forest models, and output tensors from that given layer are used to evaluate the deep forest models. Deep forest models are trained corresponding to each individual layer in the neural network.

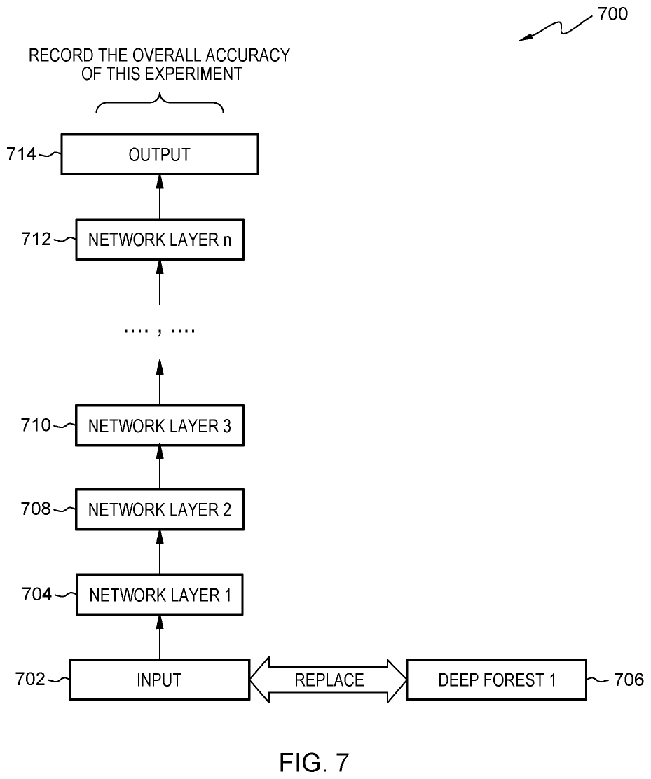

FIG. 7 shows an example neural network model 700, experimented with replacing some network layers of a neural network model with deep forest tree layers, including: (i) input 702; (ii) network layer 1 704; (iii) deep forest 706; (iv) network layer 2 708; (v) network layer 3 710; (vi) network layer n 712; and (vii) output 714. In this example experiment, network layer 1 704 is replaced with deep forest 1 706. Input 702 is then provided to deep forest 1 706 as input, and the output from deep forest 1 706 is then provided to network layer 2 708 (instead of output from network layer 1 704). The subsequent layers of neural network 700 then execute as normal, with the resulting output, output 714, recorded corresponding to this version of neural network 700 where network layer 1 704 was replaced with a deep forest layer. This output is then evaluated for accuracy against the output of neural network 700 with none of its layers replaced with deep forests. Subsequent experiments are then executed, with each experiment corresponding to replacing a different layer of neural network 700 with a corresponding deep forest layer, with their resulting outputs recorded and evaluated as in the first experiment. Afterwards, the outputs of each experiment are ranked relative to each other, from low to high, such that the ranking indicates which replaced network layers have the least impact upon the ultimate accuracy of neural network 700. With this ranking, a modified neural network is generated corresponding to neural network 700 with some network layers replaced with deep forest layers (replacing low ranked network layers, or network layers with a corresponding deep forest layer that relatively accurately simulated the network layer) and the number of network layers replaced based on accuracy and response speed requirements for deployment of neural network 700 in a target environment.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

In an Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, and application-specific integrated circuit (ASIC) based devices.

We: this document may use the word “we,” and this should be generally be understood, in most instances, as a pronoun style usage representing “machine logic of a computer system,” or the like; for example, “we processed the data” should be understood, unless context indicates otherwise, as “machine logic of a computer system processed the data”; unless context affirmatively indicates otherwise, “we,” as used herein, is typically not a reference to any specific human individuals or, indeed, and human individuals at all (but rather a computer system).

What is claimed is:

1. A computer-implemented method (CIM) comprising:
receiving a deep learning model with corresponding training input datasets and training labels;
extracting output tensors from network layers of the deep learning model;
for at least some network layers of the deep learning model, training a set of tree models, where a given tree model corresponds to an individual network layer; and
generating a set of experimental deep learning models, with each experimental deep learning model corresponding to a copy of the deep learning model having a different network layer replaced with a tree model from the set of tree models.

2. The CIM of claim 1, further comprising:
ranking the experimental deep learning model of the set of experimental deep learning models based, at least in part, on an accuracy metric.

3. The CIM of claim 2, wherein the accuracy metric is determined by comparing output of the experimental deep learning models with output of the deep learning model using the training input datasets and the training labels.

4. The CIM of claim 2, further comprising:
generating a modified deep learning model with at least one network layer replaced by a tree model from the set of tree models.

5. The CIM of claim 4, wherein replacing the at least one network layer is based, at least in part, on the ranking of experimental deep learning models, where experimental deep learning models corresponding to high accuracy metrics indicate which network layers of the deep learning model are replaceable by tree models with relatively lesser impacts upon output accuracy of the modified deep learning model relative to the deep learning model.

6. The CIM of claim 4, further comprising:
outputting the modified deep learning model to a CPU reliant environment.

7. A computer program product (CPP) comprising:
a machine readable storage device; and
computer code stored on the machine readable storage device, with the computer code including instructions for causing a processor(s) set to perform operations including the following:
receiving a deep learning model with corresponding training input datasets and training labels,
extracting output tensors from network layers of the deep learning model,
for at least some network layers of the deep learning model, training a set of tree models, where a given tree model corresponds to an individual network layer, and
generating a set of experimental deep learning models, with each experimental deep learning model corresponding to a copy of the deep learning model having a different network layer replaced with a tree model from the set of tree models.

8. The CPP of claim 7, wherein the computer code further includes instructions for causing the processor(s) set to perform the following operations:
ranking the experimental deep learning model of the set of experimental deep learning models based, at least in part, on an accuracy metric.

9. The CPP of claim 8, wherein the accuracy metric is determined by comparing output of the experimental deep learning models with output of the deep learning model using the training input datasets and the training labels.

10. The CPP of claim 8, wherein the computer code further includes instructions for causing the processor(s) set to perform the following operations:
generating a modified deep learning model with at least one network layer replaced by a tree model from the set of tree models.

11. The CPP of claim 10, wherein replacing the at least one network layer is based, at least in part, on the ranking of experimental deep learning models, where experimental deep learning models corresponding to high accuracy metrics indicate which network layers of the deep learning model are replaceable by tree models with relatively lesser impacts upon output accuracy of the modified deep learning model relative to the deep learning model.

12. The CPP of claim 10, wherein the computer code further includes instructions for causing the processor(s) set to perform the following operations:
outputting the modified deep learning model to a CPU reliant environment.

13. A computer system (CS) comprising:
a processor(s) set;
a machine readable storage device; and
computer code stored on the machine readable storage device, with the computer code including instructions for causing the processor(s) set to perform operations including the following:
receiving a deep learning model with corresponding training input datasets and training labels,
extracting output tensors from network layers of the deep learning model,
for at least some network layers of the deep learning model, training a set of tree models, where a given tree model corresponds to an individual network layer, and
generating a set of experimental deep learning models, with each experimental deep learning model corresponding to a copy of the deep learning model having a different network layer replaced with a tree model from the set of tree models.

14. The CS of claim 13, wherein the computer code further includes instructions for causing the processor(s) set to perform the following operations:
ranking the experimental deep learning model of the set of experimental deep learning models based, at least in part, on an accuracy metric.

15. The CS of claim 14, wherein the accuracy metric is determined by comparing output of the experimental deep learning models with output of the deep learning model using the training input datasets and the training labels.

16. The CS of claim 14, wherein the computer code further includes instructions for causing the processor(s) set to perform the following operations:
generating a modified deep learning model with at least one network layer replaced by a tree model from the set of tree models.

17. The CS of claim 16, wherein replacing the at least one network layer is based, at least in part, on the ranking of experimental deep learning models, where experimental deep learning models corresponding to high accuracy metrics indicate which network layers of the deep learning model are replaceable by tree models with relatively lesser impacts upon output accuracy of the modified deep learning model relative to the deep learning model.

18. The CS of claim 16, wherein the computer code further includes instructions for causing the processor(s) set to perform the following operations:
outputting the modified deep learning model to a CPU reliant environment.
